(19) United States
(12) Patent Application Publication
(10) Pub. No.: US 2007/0047936 A1
(43) Pub. Date: Mar. 1, 2007

(54) Image sensing apparatus

(75) Inventor: Toshihiko Hirota, Osaka (JP)

Correspondence Address: BRINKS HOFER GILSON & LIONE, P.O. BOX 10395, CHICAGO, IL, 60610, US

(73) Assignee: Konica Minolta Photo Imaging, Inc.

(21) Appl. No.: 11/511,847

(22) Filed: Aug. 28, 2006

(30) Foreign Application Priority Data
Aug. 29, 2005 (JP) 2005-247646

(51) Int. Cl. G03B 17/00

(52) U.S. Cl. 396/55

(57) ABSTRACT

An image sensing apparatus e.g. a digital camera includes an optical path splitter for splitting a flux of light from an object guided through a photographing optical system into optical paths; an image sensor for photoelectrically converting the light passing along a first optical path of the optical paths; a driver for driving the image sensor on a plane intersecting with an optical axis of the photographing optical system; a shake detector for detecting a shake given to the image sensing apparatus; a driver controller for controlling the driver to drive the image sensor based on an output from the shake detector to correct an image blur of an object light image captured on a light receiving plane of the image sensor; an anti-shake optical system disposed on a second optical path different from the first optical path of the optical paths; and a mechanical linking mechanism for enabling driving of the anti-shake optical system in association with the driving of the image sensor by the driver.

This application is based on Japanese Patent Application No. 2005-247646 filed on Aug. 29, 2005, the contents of which are hereby incorporated by reference.

### BACKGROUND OF THE INVENTION

1. Field of the Invention

The present invention relates to an image sensing apparatus such as a digital camera, and more particularly to an image sensing apparatus including a photographing optical system equipped with an anti-shake mechanism against camera shake.

2. Description of the Related Art

There have been widely known image sensing apparatuses having a so-called anti-shake function in order to enable secure photographing in cases where “shake” such as camera shake is likely to occur during the photographing by a telephoto lens or of an object in the dark (requiring a longer exposure) with the apparatuses hand-held. This anti-shake function corrects a displacement of an optical axis by driving an anti-shake optical system or an image sensing device based on shake in the case of the displacement of the optical axis resulting from the shake given to the image sensing apparatus, for example, due to the hand shake of a user.

Japanese Unexamined Patent Publication No. 9-329820 discloses a non-TTL viewfinder camera equipped with a viewfinder optical system independently of a photographing optical system, wherein an anti-shake optical system provided in the photographing optical system, and an anti-shake optical system provided in the viewfinder optical system are driven based on a shake amount detected by a shake detection sensor. The publication also discloses a technique of driving the two anti-shake optical systems by a common driver.

Japanese Unexamined Patent Publication No. 9-211520 proposes an arrangement of magnifying camera shake by eccentrically driving a part of a viewfinder optical system in order to let a user visually recognize shake of the camera body due to a hand shake of the user.

U.S. Published Patent Application No. 2005-0052538 recites a camera comprising a movable mirror disposed between a photographing optical system and an image sensing device, a mechanism for driving the movable mirror between a position for guiding an incident light flux onto an optical viewfinder, and a position for guiding the incident light flux onto the image sensing device, and a mechanism for driving the image sensing device for an anti-shake operation. In the camera, the movable mirror is retracted away from an optical path from the photographing optical system to the image sensing device in response to setting of the anti-shake mode, whereby an image captured by the image sensing device is displayed on a monitor.

A single-lens reflex camera with a mechanism for performing an anti-shake operation by driving an image sensing device has the following drawback. Specifically, in a camera provided with an anti-shake optical system in a photographing optical system, an object light image after the anti-shake operation is guided to the image sensing device and to an optical viewfinder. With the arrangement, a user can visually recognize the object light image with less or no image blur resulting from the camera shake through the optical viewfinder. Generally, however, the single-lens reflex camera is configured to split a light flux guided through the photographing optical system into plural light fluxes so that one of the light fluxes is guided to the image sensing device. If the camera having the above configuration is loaded with a mechanism for performing an anti-shake operation by driving the image sensing device, an image blur of the light image constituted of the rest of the light fluxes is not eliminated because the anti-shake operation is performed for an image on a light receiving plane of the image sensing device.

For instance, in the case of a camera constructed such that one of light fluxes after the light flux splitting is guided to an optical viewfinder, the aforementioned anti-shake operation is not performed for the object light image guided to the optical viewfinder. As a result, whereas the object light image captured by the image sensing device has no or less image blur, the object light image that is visually recognized through the optical viewfinder contains an image blur due to the camera shake.

There is proposed an arrangement of providing an anti-shake optical system in an optical system of the optical viewfinder, and providing a driver for driving the anti-shake optical system independently of the driver for driving the image sensing device. With the arrangement, the driver provided in the optical viewfinder drives the anti-shake optical system to suppress an image blur of the object light image visually recognized through the optical viewfinder. The arrangement, however, gives rise to cost increase and size increase of the image sensing apparatus.

As mentioned above, none of the publications has succeeded in solving the drawbacks involved in the single-lens reflex camera in the case where the camera is loaded with a mechanism for performing an anti-shake operation by driving an image sensing device.

### SUMMARY OF THE INVENTION

In view of the above, an object of the invention is to provide an image sensing apparatus having an arrangement of splitting a light flux guided from a photographing optical system into a light flux toward an image sensor and a light flux toward a mechanism other than the image sensor, and an anti-shake mechanism of performing an anti-shake operation by driving the image sensor to provide an anti-shake control for a mechanism other than the image sensor, utilizing the anti-shake mechanism.

An aspect of the invention that has attained the object is directed to an image sensing apparatus comprising: an optical path splitter for splitting a flux of light from an object guided through a photographing optical system into a plurality of optical paths; an image sensor for photoelectrically converting the light passing along a first optical path of the optical paths; a driver for driving the image sensor on a plane intersecting with an optical axis of the photographing optical system; a shake detector for detecting a shake given to the image sensing apparatus; a driver controller for controlling the driver to drive the image sensor based on an output from the shake detector so as to correct an image blur of a light image of the object captured on a light receiving plane of the image sensor; an anti-shake optical system disposed on a second optical path different from the first optical path of the optical paths; and a mechanical linking mechanism for enabling driving of the anti-shake optical system in association with the driving of the image sensor by the driver.

Another aspect of the invention is directed to an image sensing apparatus comprising: a photographing optical system; an image sensor for photoelectrically converting light from an object guided through the photographing optical system; an optical viewfinder for optically displaying a light image of the object guided through the photographing optical system; an optical path splitter for selectively guiding a flux of the light guided through the photographing optical system along a first optical path directed to the image sensor and along a second optical path directed to the optical viewfinder; a driver for driving the image sensor on a plane intersecting with an optical axis of the photographing optical system; a shake detector for detecting a shake given to the image sensing apparatus; an anti-shake optical system disposed on the second optical path; a driver controller for controlling the driver to drive the image sensor based on an output from the shake detector so as to correct an image blur of a light image of the object captured on a light receiving plane of the image sensor; and a mechanical linking mechanism for enabling driving of the anti-shake optical system in association with the driving of the image sensor by the driver.

These and other objects, features and advantages of the present invention will become more apparent upon reading of the following detailed description along with the accompanying drawings.

### BRIEF DESCRIPTION OF THE DRAWINGS

FIG. 1A is a front external view of a digital camera embodying the invention.

FIG. 1B is a rear external view of the digital camera.

FIG. 2 is a perspective side view of the digital camera.

FIG. 3 is a rear view of the digital camera in FIG. 2, with a side chassis being detached.

FIG. 4 is an exploded perspective view showing an arrangement of an anti-shake unit.

FIG. 5 is a block diagram showing an electrical configuration of the digital camera.

FIGS. 6A and 6B are a flowchart showing an anti-shake processing to be executed by the digital camera.

FIG. 7 is a front view of a first modified embodiment showing a mechanical arrangement of moving a viewfinder anti-shake optical system in association with an image sensor.

FIG. 8 is a plan view showing the arrangement of the first modified embodiment.

FIG. 9 is a side view showing the arrangement of the first modified embodiment.

FIG. 10 is a rear view showing the arrangement of the first modified embodiment.

FIG. 11 is a side view showing an arrangement of a second modified embodiment for moving an optical device provided in a focus detecting section in association with an image sensor.

### DETAILED DESCRIPTION OF THE PREFERRED EMBODIMENTS

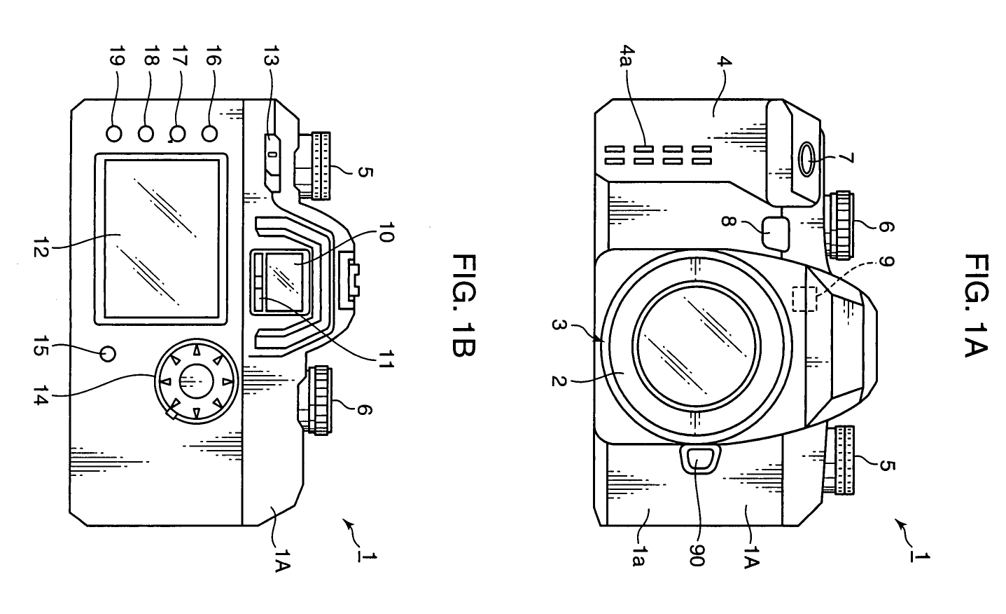

In the following, a digital camera, as an example of an image sensing apparatus according to an embodiment of the invention is described referring to the drawings. FIGS. 1A and 1B are diagrams showing an external construction of the digital camera 1 embodying the invention. FIG. 1A is a front external view of the digital camera 1, and FIG. 1B is a rear external view of the digital camera 1.

As shown in FIG. 1A, the digital camera 1 is a single lens reflex digital still camera provided with a camera body 1A, and a lens unit 2, as a photographing optical system, which is detachably or exchangeably attached to a substantially middle part on a front face of the camera body 1A.

The camera body 1A has a mount portion 3 for mounting the lens unit 2 substantially in the middle on the front face thereof, a grip portion 4 which protrudes forward on a left end portion of the front face thereof for allowing a user to securely grip or hold the camera 1 with his or her hand(s), a control value setting dial 5 arranged on an upper right portion of the camera body 1A for allowing the user to set a control value, a mode setting dial 6 arranged on an upper left portion of the camera body 1A for allowing the user to switch the photographing mode to an intended mode, a shutter button 7, as an operation input section, which is arranged on a top portion of the grip portion 4 for allowing the user to designate start or end of a photographing operation i.e. exposure, and a flashlight section 8. The camera body 1A internally has a shake detecting sensor 9 as a shake detector.

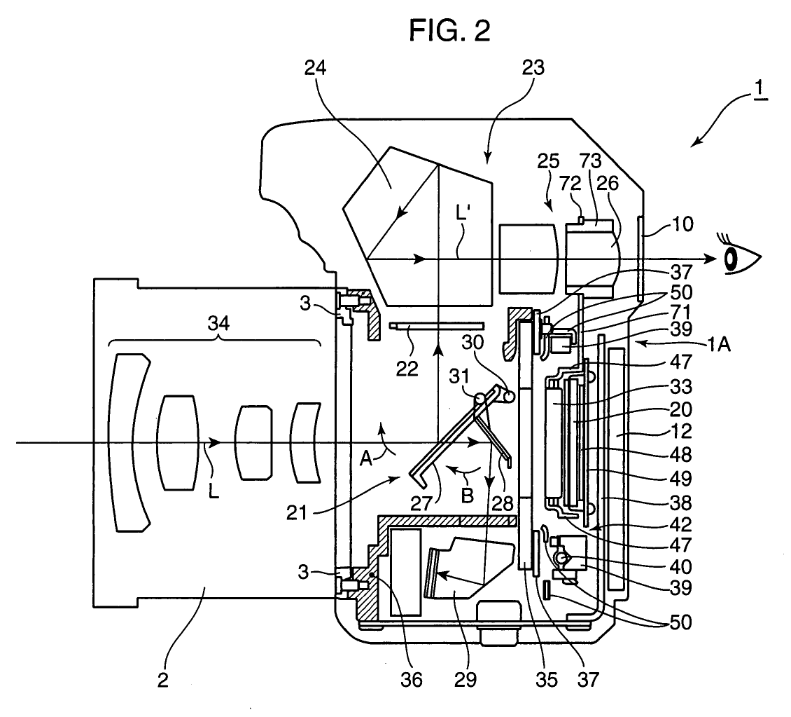

The lens unit 2 functions as a lens aperture for receiving light i.e. a light image from an object, and includes a taking lens assembly for guiding the light to an image sensor 20 (see FIG. 2) and to a viewfinder section 23 (see FIG. 2), which are arranged inside the camera body 1A and will be described later. The lens unit 2 is so configured as to perform focus control by moving the positions of respective lens elements thereof manually or automatically to their intended positions.

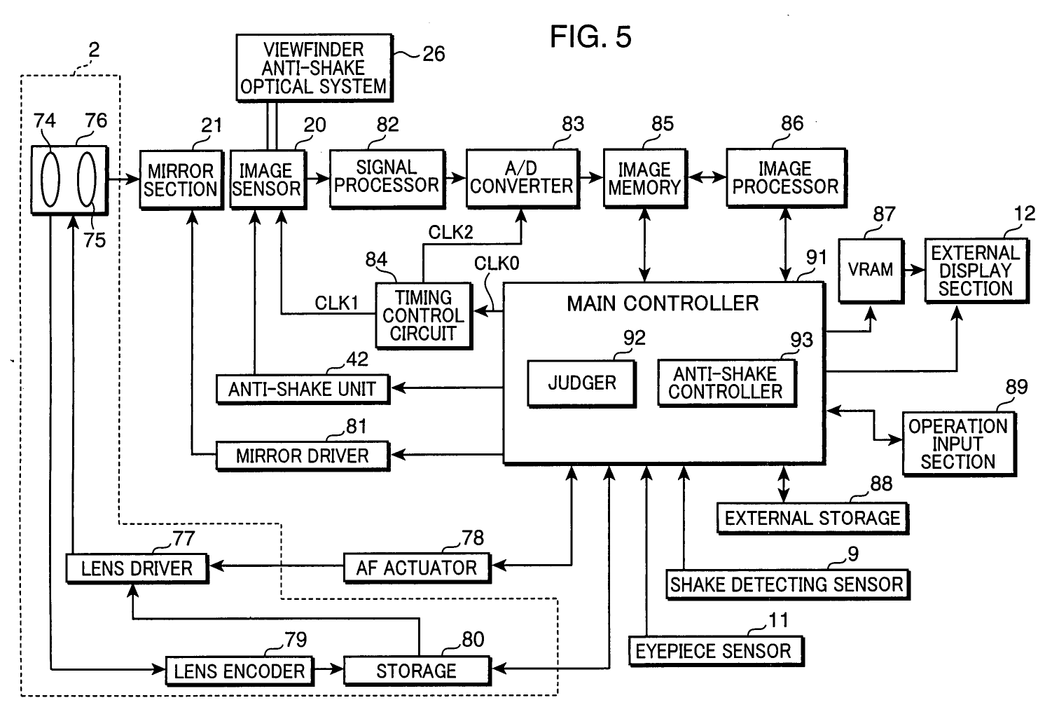

A detachment button 90 for allowing the user to detachably attach the lens unit 2, plural electric contacts (not shown) for electrically connecting the lens unit 2 with the camera body 1A, and plural couplers (not shown) for mechanically connecting the lens unit 2 with the camera body 1A are provided in the vicinity of the mount portion 3. The electric contacts are provided for enabling electrical communication, specifically, sending information inherent to the lens unit 2, such as f-number and focal length, from a lens read-only memory (lens ROM) incorporated in the lens unit 2 to a main controller 91 (see FIG. 5) in the camera body 1A, and sending information relating to the positions of a zoom lens group 74 (see FIG. 5) and a focus lens group 75 (see FIG. 5) in the lens unit 2 to the main controller 91, which will be described later. The couplers are adapted to transmit driving forces of drive motors provided in the camera body 1A for driving the focus lenses and the zoom lenses to the lens elements in the lens unit 2.

The grip portion 4 includes a grip sensor 4a for detecting whether the user has gripped or held the digital camera 1. The grip sensor 4a has plural electrodes, and is designed in such a manner that in response to detection of a contact with any one of the electrodes by the grip sensor 4a, a weak current is allowed to flow in an unillustrated electric circuit including the contacted electrode, thereby detecting that the user has gripped the digital camera 1.

The control value setting dial 5 is adapted to set various control values in photographing. The mode setting dial 6 is adapted to set various photographing modes such as auto-exposure (AE) control mode, auto-focusing (AF) control mode, still image photographing mode for photographing still images, moving image photographing mode (continuous photographing mode) for photographing moving images, and flash mode.

The shutter button 7 is a depressing type switch, which is settable to a halfway pressed state where the shutter button 7 is depressed halfway down, and to a fully pressed state where the shutter button 7 is depressed fully down. When the shutter button 7 is depressed halfway down in the still image photographing mode, a preparatory operation for photographing a still image of an object such as setting an exposure control value and focus adjustment is executed. Subsequently, when the shutter button 7 is depressed fully down, a photographing operation, namely, a series of operations comprising exposing the image sensor 20 to be described later, applying a predetermined image processing to image signals acquired by the exposure, and recording the processed signals in an external storage 88 (see FIG. 5), are executed.

On the other hand, when the shutter button 7 is depressed fully down in the moving image photographing mode, a photographing operation, namely, a series of operations comprising exposing the image sensor, processing image signals acquired by the exposure, and recording the processed signals into the external storage 88, are executed. Subsequently, when the shutter button 7 is depressed fully down again, the photographing operation is terminated. The halfway pressing of the shutter button 7 is detected by turning on of an unillustrated switch S1, and the fully pressing of the shutter button 7 is detected by turning on of an unillustrated switch S2.

The flashlight section 8 is provided at an appropriate position on the front face of the camera body 1A, between the lens unit 2 and the grip portion 4. The flashlight section 8 fires flashlight onto the object if the exposure amount for the object is judged to be insufficient.

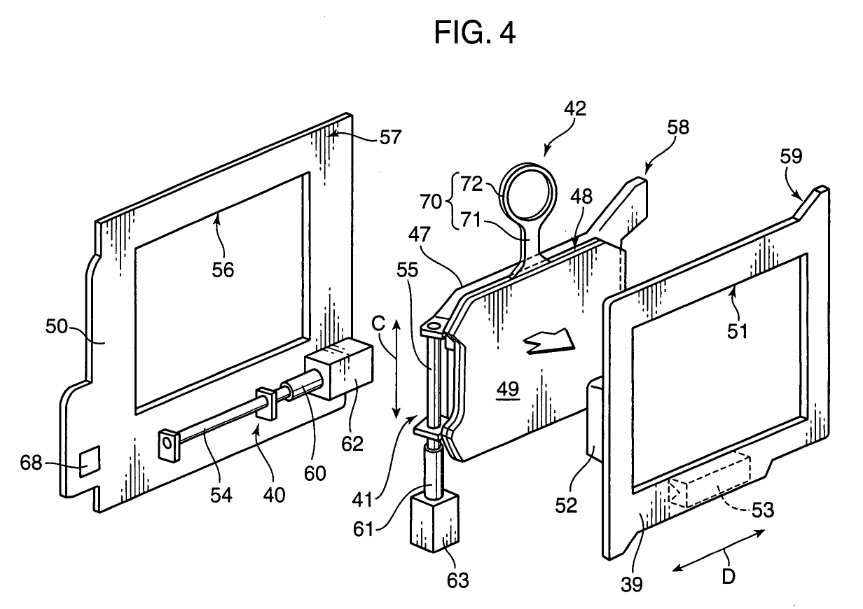

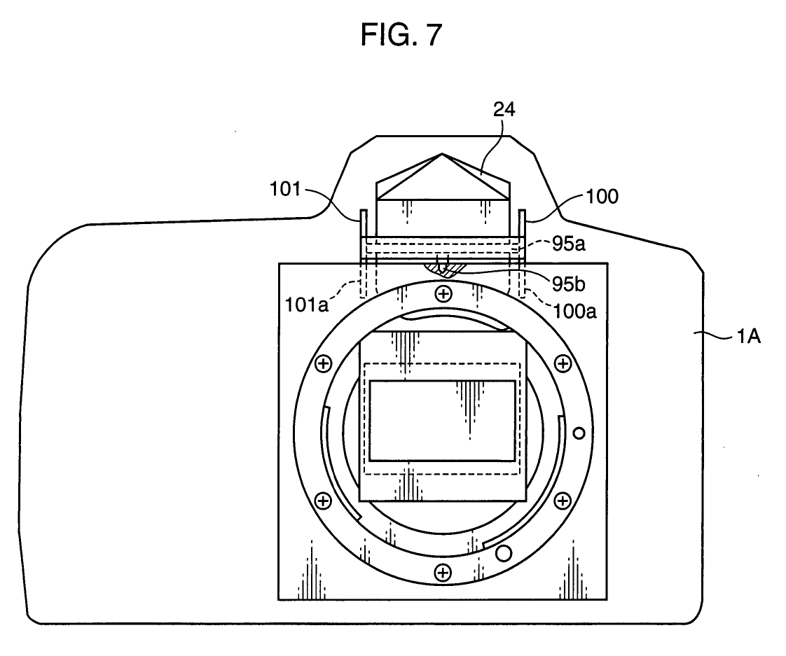

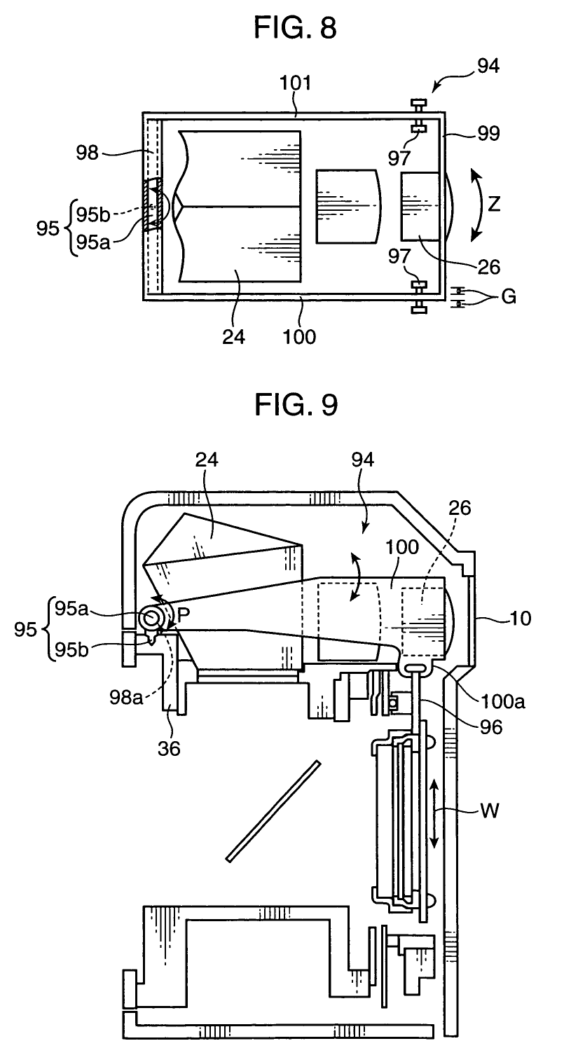

The shake detecting sensor 9 is provided at an appropriate position in the camera body 1A to detect shake information such as a shake direction or a shake amount of the object to be detected, specifically, the digital camera 1 or the camera body 1A in this embodiment. The shake information detected by the shake detecting sensor 9 is used for anti-shake control to be executed by an anti-shake unit 42 (see FIGS. 4 and 5), which will be described later. The shake detecting sensor 9 includes a yaw gyro for detecting a shake amount based on an angular velocity of the camera body 1A in yaw directions i.e. directions shown by the arrows “Z” in FIG. 8, and a pitch gyro for detecting a shake amount based on an angular velocity of the camera body 1A in pitch directions i.e. directions shown by the arrows “W” in FIG. 9. An exemplified gyro is constructed such that a certain voltage is applied to a piezoelectric device to oscillate the piezoelectric device, and distortion arising from Coriolis action that is generated when an angular velocity due to swing of the camera body 1A is applied to the oscillating piezoelectric device is read as an electric signal.

A viewfinder window 10 is formed substantially in the middle on an upper portion on the rear face of the camera body 1A. An object light image through the lens unit 2 is guided to the viewfinder window 10, whereby the user is enabled to visually recognize the object light image (hereinafter, also called as “viewfinder image”) through the viewfinder window 10.

An eyepiece sensor 11 as a contact sensor is arranged below the viewfinder window 10 to detect whether the user has viewed a viewfinder image through the viewfinder window 10, namely, whether the user's eye has contacted or come close to an area including the viewfinder window 10. The eyepiece sensor 11 is a photoreflector comprising a light emitting device and a light receiving device in pair. When the user views a viewfinder image through the viewfinder window 10, light emitted from the light emitting device of the photoreflector is reflected by the body of the user, and the reflected light is received by the light receiving device of the photoreflector. The main controller 91 to be described later judges that the user has viewed the viewfinder image through the viewfinder window 10 upon receiving a signal indicating that the reflected light has been received by the light receiving device of the photoreflector.

An external display section 12 as an LCD monitor is provided substantially in the middle on the rear face of the camera body 1A. The external display section 12 is a color liquid crystal display device, and is adapted to display a menu screen for allowing the user to set the AE/AF control mode, still image/moving image photographing mode, or other photographing conditions, and to display photographed images that have been recorded in the external storage 88 for playback in the playback mode.

A power switch 13 is provided on an upper left portion of the external display section 12. The power switch 13 is a 2-contact slide switch, for instance. Setting the contact of the power switch 13 to the left-side position turns the power of the camera 1 on, and setting the contact of the power switch 13 to the right-side position turns the power of the camera 1 off.

A direction selecting key 14 and an anti-shake switch 15 are provided on the right side of the external display section 12. The direction selecting key 14 is in the form of a circular operation button. Upward, downward, leftward, and rightward directions, and upward right, upward left, downward right, and downward left directions are detectable by pressing relevant portions of the direction selecting key 14. The direction selecting key 14 has multi-functions. For instance, the direction selecting key 14 functions as an operation switch for allowing the user to alter the item selected on the menu screen displayed on the external display section 12 for setting a desired photographic scene, and also functions as an operation switch for allowing the user to alter the selected frame of an image for playback on an index image screen where plural thumbnail images are displayed in a certain order. The direction selecting key 14 also functions as a zoom switch for allowing the user to change the focal lengths of the zoom lenses of the lens unit 2.

The anti-shake switch 15 is adapted to set an anti-shake mode that enables to perform secure photographing free of an image blur even in a condition that such an image blur may take place due to shake of the camera body 1A or the like, e.g., one-hand photographing, telephotographing, or photographing in a dark place where long time exposure is required. Each time the anti-shake switch 15 is depressed, the anti-shake mode is changed over between on and off. The anti-shake switch 15 may be a 2-contact slide switch, as in the case of the power switch 13.

A cancel switch 16, a determination switch 17, a menu display switch 18, and an external display changeover switch 19 are provided on the left side of the external display section 12 for allowing the user to designate display on the external display section 12 and to manipulate display contents displayed on the external display section 12. The cancel switch 16 is a switch for allowing the user to cancel the contents selected on the menu screen. The determination switch 17 is a switch for allowing the user to determine the contents selected on the menu screen. The menu display switch 18 is a switch for allowing the user to display the menu screen on the external display section 12 or to change over the contents of the menu screen such as a photographic scene setting screen and a mode setting screen regarding exposure control. Each time the menu display switch 18 is depressed, the contents of the menu screen is changed. The external display changeover switch 19 is a switch for allowing the user to turn on and off the display of the external display section 12. Each time the external display changeover switch 19 is depressed, display on the external display section 12 is alternately turned on and off. Alternatively, various push-type or dial-type switches other than the aforementioned switches, such as a zoom switch, an exposure correction switch, and an AE lock switch may be provided at appropriate positions of the camera body 1A.

Next, an internal arrangement of the digital camera 1 is described. FIG. 2 is a perspective side view of the digital camera 1, with the lens unit 2 attached to the camera body 1A. The image sensor 20 of a rectangular shape is provided at an appropriate position in the camera body 1A on an optical axis “L” of a lens group 34 in the lens unit 2, on a plane perpendicularly intersecting the optical axis “L”.

The image sensor 20 photoelectrically converts an object light image guided through the lens unit 2 into image signals of color components of red (R), green (G), and blue (B) based on the received light amount of the object light image. More specifically, the image sensor 20 comprises a single CCD color area sensor of a so-called “Bayer matrix” in which patches of color filters each in red (R), green (G), and blue (B) are attached on respective surfaces of charge coupled devices (CCDs) in a checker pattern in a two-dimensional manner. The image sensor 20 may be a CCD image sensor, a CMOS image sensor, a VMIS image sensor, or the like.

A mirror section 21 as an optical path splitter is disposed on the optical path “L” at such a position as to reflect the object light image toward the viewfinder section 23. Apart of the object light image that has propagated through the lens unit 2 is reflected upwardly by the mirror section 21, specifically, by a main mirror 27 to be described later, and is focused on a focusing glass 22 i.e. a focusing screen, while the rest of the object light image is transmitted through the mirror section 21.

The viewfinder section 23 includes a penta prism 24, an eyepiece lens unit 25, and the viewfinder window 10. The penta prism 24 is an optical device having a pentagonal shape in cross section, and is a prism member for turning the object light image that has been incident from a lower part of the viewfinder section 23 into an upright image by turning the light image upside down through internal reflection.

The eyepiece lens unit 25 guides the upright object light image formed by the penta prism 24 toward the viewfinder window 10. The eyepiece lens unit 25 includes plural optical devices with their convex portions being directed toward the viewfinder window 10. The respective optical devices have a positive optical power. Also, as will be described later, one of the optical devices of the eyepiece lens unit 25 i.e. an optical device 26 as an anti-shake optical system is integrally movable with the image sensor 20 on a plane substantially orthogonal to an optical axis “L′” of the viewfinder section 23. With the above configuration, the viewfinder section 23 functions as an optical viewfinder for allowing the user to confirm an object light image i.e. a viewfinder image during a photographing standby operation.

The mirror section 21 includes the main mirror 27 and a sub mirror 28. The sub mirror 28 is arranged on the rear side of the main mirror 27 and is rotatably tilted toward the rear surface of the main mirror 27. A central part or the entirety of the main mirror 27 constitutes a half mirror. A part of the object light image that has transmitted through the central part of the main mirror 27 is reflected on the sub mirror 28, and the reflected object light image is incident onto a focus detecting section 29. The focus detecting section 29 is a so-called AF sensor including a metering device or the like for detecting information as to whether the object light image has been focused.

The mirror section 21 is a so-called quick return mirror. During exposure, the main mirror 27 of the mirror section 21 is quickly pivoted upwardly in the direction shown by the arrow “A” in FIG. 2 about the axis of a rotational shaft 30 from the tilted position shown in FIG. 2, and is retained at a certain position below the focusing glass 22. At this time, the sub mirror 28 is pivoted in the direction shown by the arrow “B” in FIG. 2 about the axis of a rotational shaft 31 on the rear side of the main mirror 27. When the main mirror 27 is retained at the position below the focusing glass 22, the sub mirror 28 is folded substantially in parallel with the main mirror 27, which is called a horizontal position. As a result of the operation, the object light image through the lens unit 2 reaches the image sensor 20 without being blocked by the mirror section 21 for exposure of the image sensor 20. When the exposure is finished, the mirror section 21 is returned to the initial position.

A low-pass filter 33 as an optical filter is arranged on the optical axis “L” in front of the image sensor 20 to prevent pseudo color image formation or generation of moiré in color images. A shutter section 35 is provided in front of the low-pass filter 33. The shutter section 35 is controllably opened and closed as timed with the exposure. The shutter section 35 is a vertically traveling focal plane shutter, with a forward portion thereof being brought into contact with a rear end portion of a frame member 36, and a rear portion thereof being pressed against a shutter pressing plate 37. The shutter pressing plate 37 is fixed to the frame member 36 by unillustrated screws. With this arrangement, the shutter section 35 is fixed to the frame member 36. The external display section 12 is disposed between the rear face of the image sensor 20 and a side chassis 38 in parallel to the light receiving plane of the image sensor 20.

The image sensor 20 includes the anti-shake unit 42 for performing an anti-shake operation for an object light image captured on the light receiving plane of the image sensor 20 in cooperation with a slider 39 and actuators i.e. a yaw actuator 40 (see FIG. 4) and a pitch actuator 41 (see FIG. 4), which will be described later. The arrangement and operation of the anti-shake unit 42 will be described later in detail.

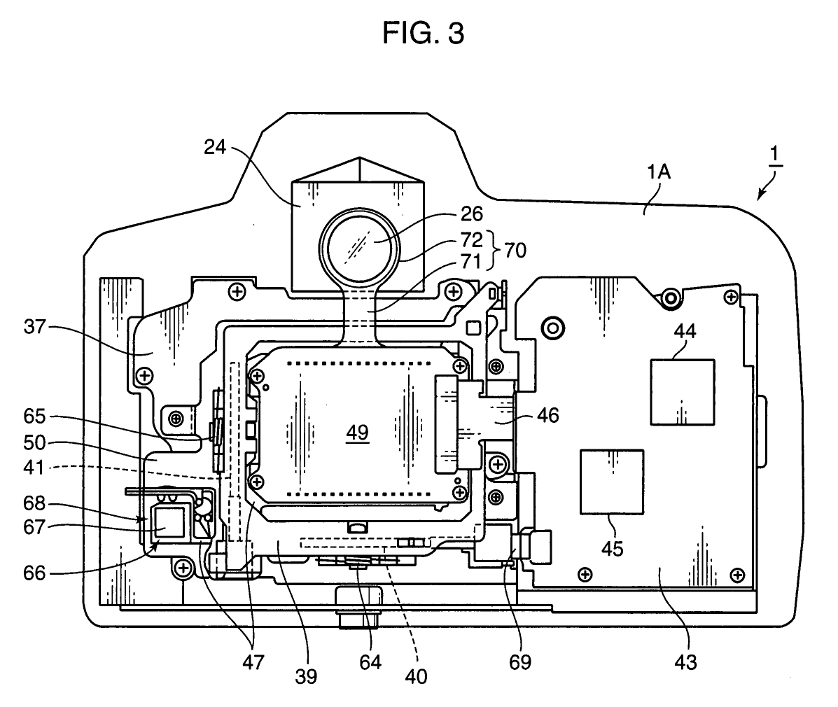

FIG. 3 is a rear view of the digital camera 1 showing a state that the side chassis 38 in FIG. 2 is detached from the camera body 1A. As shown in FIG. 3, a control circuit board 43 is disposed adjacent the image sensor 20. On the control circuit board 43, mounted are electronic components such as an image processing circuit 44 for performing a predetermined signal processing i.e. an image processing for image data e.g. an application specific integration circuit (ASIC) for image processing, and an anti-shake control circuit 45 for controlling anti-shake driving to be described later e.g. an ASIC for anti-shake control. The control circuit board 43 and the image sensor 20 are electrically connected by a first flexible wiring 46.

FIG. 4 is a perspective view showing an arrangement of the anti-shake unit 42. As shown in FIG. 4, the anti-shake unit 42 includes the image sensor 20 and the low-pass filter 33 shown in FIG. 2, an image sensor holder 47 for supporting the image sensor 20 and the low-pass filter 33, the slider 39 for supporting the image sensor holder 47, a heat releaser 48 disposed on the rear side of the image sensor 20, an image sensor substrate 49 disposed on the rear side of the heat releaser 48, the yaw actuator 40, the pitch actuator 41, and an anti-shake bedplate 50.

The image sensor substrate 49 is a substantially rectangular base plate on which the image sensor 20 is mounted (in this embodiment, a CCD substrate). The image sensor 20 is mounted on the image sensor substrate 49, with the heat releaser 48 being disposed between the image sensor 20 and the image sensor substrate 49. The heat releaser 48 is a plate-like member made of a predetermined metal material, and is adapted to release heat generated by driving i.e. photoelectric conversion of the image sensor 20 outside. The image sensor holder 47 is a frame member of a substantially rectangular shape in cross section, with an opening formed in a depthwise direction of the camera body 1A. The low-pass filter 33 (see FIG. 2) is attached to a front portion of the frame-like image sensor holder 47. The image sensor 20 (see FIG. 2) is mounted on the rear surface of the lower-pass filter 33. The image sensor substrate 49 is fixedly attached to the image sensor holder 47 by unillustrated screws in such a manner that the image sensor 20 is pressed against the image sensor holder 47 together with the heat releaser 48 by the image sensor substrate 49.

The pitch actuator 41 is provided on a widthwise end portion i.e. a left end portion of the image sensor holder 47 in FIG. 4. The image sensor holder 47 is attached to the slider 39 in such a manner that the image sensor holder 47 is slidably movable relative to the slider 39 in the pitch directions i.e. vertical directions shown by the arrows “C” in FIG. 4 by way of the pitch actuator 41. The slider 39 is a substantially planar-shaped frame member, with a rectangular opening 51 larger than the size of the image sensor substrate 49 being formed substantially in the middle thereof.

A rod receiving portion 52 is fixed to the slider 39 at a position opposing the pitch actuator 41, and is formed with a V-shaped groove for slidably receiving a rod portion 55 of the pitch actuator 41 to be described later for sliding engagement. Also, a rod receiving portion 53 having the same configuration as the rod receiving portion 52 is fixed to a lower portion of the slider 39 at a position opposing the yaw actuator 40. Frictional connection of the rod portion 54 (55) with the rod receiving portion 53 (52) is realized by holding the rod portion 54 (55) between a yaw pressing plate (pitch pressing plate) and the rod receiving portion 53 (52), with urging forces being exerted by an urging member 64 (65) (see FIG. 3) such as a spring member.

The anti-shake bedplate 50 is fixed to the shutter pressing plate 37 (see FIG. 2), and serves as a base block of the anti-shake unit 42 for supporting the slider 39 in a state that the image sensor holder 47 is supported on the slider 39. The anti-shake bedplate 50 is a frame member with an opening 56 having substantially the same size as the opening 51 of the slider 39 being formed substantially in the middle thereof. The yaw actuator 40 is fixed to a vertically lower end portion of the frame-like anti-shake bedplate 50. The slider 39 is attached to the anti-shake bedplate 50 in such a manner that the rod receiving portion 53 is slidably movable relative to the rod portion 54 of the yaw actuator 40 in the yaw directions i.e. sideways directions shown by the arrows “D” in FIG. 4.

An upper right end corner portion 57 of the anti-shake bedplate 50 and a corner portion 59 of the slider 39 are interconnected to each other by unillustrated urging members such as spring members, while holding a corresponding corner portion 58 of the image sensor holder 47. Specifically, the corner portion 57 and the corner portion 59 are interconnected in a state that the corner portion 59 is pressed against the corner portion 57, with unillustrated ball members disposed on front and rear surfaces of the corner portion 58 of the image sensor holder 47 being sandwiched between the corner portion 58, and the corner portion 57, 59, respectively. With this arrangement, the slider 39 and the image sensor holder 47 are pressed against the anti-shake bedplate 50 in a state that the slider 39 and the image sensor holder 47 are slidably movable in the yaw directions, and that the image sensor holder 47 is slidably movable in the pitch directions, thereby securely holding the image sensor holder 47 and the slider 39 to the anti-shake bedplate 50 without likelihood of detachment.

The yaw actuator 40 and the pitch actuator 41 each is an ultrasonic-driven impact-type linear actuator i.e. a piezoelectric actuator. The yaw actuator 40 (pitch actuator 41) comprises the rod portion 54 (55), a piezoelectric device 60 (61), and a weight member 62 (63). The rod portion 54 (55) is a rod-shaped driving shaft which is oscillated by the piezoelectric device 60 (61) and has a predetermined shape i.e. a circular shape in cross section. The rod portion 54 (55) is frictionally connected to the rod receiving portion 53 (52).

The piezoelectric device 60 (61) is made of ceramic or a like material, and is expanded and contracted in accordance with a voltage applied thereto to oscillate the rod portion 54 (55) in accordance with the expansion and contraction. The expansion and contraction of the piezoelectric device 60 (61) are performed by alternately repeating high-speed expansion and low-speed extraction, or low-speed expansion and high-speed contraction, or equi-speed expansion and equi-speed contraction, wherein the expansion speed and the contraction speed are identical to each other. The piezoelectric device 60 (61) is for instance a laminated piezoelectric device, and is fixed to one end of the rod portion 54 (55), with a polarizing direction thereof coincident with the axial direction of the rod portion 54 (55).

A signal line drawn from the control circuit board 43 i.e. the anti-shake control circuit 45 is connected to an electrode portion of the piezoelectric device 60 (61). The expansion and contraction of the piezoelectric device 60 (61) is performed by charging or discharging i.e. reverse charging based on a drive signal outputted from the control circuit board 43. Repeating the expansion and contraction of the piezoelectric device 60 allows for moving the rod receiving portion 53, and accordingly, the slider 39 relative to the rod portion 54 back and forth, and repeating the expansion and contraction of the piezoelectric device 61 allows for moving the rod portion 55 relative to the rod receiving portion 52, and accordingly, the slider 39 back and forth. Also, the above expansion and contraction allows for suspension of the movements at their intended positions. The weight portion 62 (63) is fixed to an end of the rod portion 54 (55) opposite to the piezoelectric device 60 (61) so as to efficiently transmit the oscillation generated in the piezoelectric device 60 (61) to the rod portion 54 (55).

Thus, integrally and slidably moving the slider 39 and the image sensor holder 47 relative to the anti-shake bedplate 50 in sideways directions in accordance with the driving of the yaw actuator 40 enables to correct or cancel a shake in the yaw directions of the image sensor 20 i.e. the directions shown by the arrows “D” in FIG. 4. Also, slidably moving the image sensor holder 47 relative to the slider 39 in vertical directions in accordance with the driving of the pitch actuator 41 enables to correct or cancel a shake in the pitch directions of the image sensor 20 i.e. the directions shown by the arrows “C” in FIG. 4.

As shown in FIG. 3, a position detecting sensor 66 detects the position of the image sensor 20 in anti-shake driving or startup of the camera 1. The position detecting sensor 66 includes a magnet portion 67 and a two-dimensional hall sensor 68. The magnet portion 67 is an element for generating magnetic lines of force having a feature that a central part thereof has a particularly strong magnetic force. The magnet portion 67 is provided at a corner portion of the image sensor holder 47 and is integrally moved with the image sensor holder 47. The two-dimensional hall sensor 68 is a sensor comprising a predetermined number of hall sensing devices each of which outputs a signal in accordance with a magnitude of the magnetic line of force from the magnet portion 67, and which are arrayed in a two-dimensional manner. The two-dimensional hall sensor 68 is fixed at a predetermined position on the anti-shake bedplate 50 opposing the magnet portion 67.

The position detecting sensor 66 detects the position of the image sensor 20 by controlling the two-dimensional hall sensor 68 to detect the position of the magnet portion 67 which is moved depending on the vertical and sideways movements of the image sensor holder 47 relative to the anti-shake bedplate 50. The position detecting sensor 66 is electrically connected to the control circuit board 43 by a second flexible wiring 69 together with the yaw actuator 40 and the pitch actuator 41.

In addition to the above arrangement, as shown in FIGS. 2 through 4, a linking member 70 as a mechanical linking mechanism is provided at an upper end portion of the heat releaser 48, as a support member. The linking member 70 has an arm portion 71 extending upwardly from the upper end portion of the heat releaser 48, and an annular-shaped ring portion 72 formed at an upper end portion of the arm portion 71. The ring portion 72 has an opening, in which the optical device 26 enclosed by a protective member 73 is fitted. With this arrangement, the optical device 26 is movable on a plane substantially orthogonal to the optical axis “L′” of the viewfinder section 23 in association with the image sensor 20.

As mentioned above, whereas the mirror section 21 is set to a horizontal position when an exposure operation is carried out by the image sensor 20, the mirror section 21 is set to a tilted position in a period other than the exposure period. In other words, an object light image is selectively guided to the viewfinder section 23 and to the image sensor 20 so that there is no likelihood that the object light image display by the viewfinder section 23 and the exposure operation by the image sensor 20 are carried out concurrently.

In view of the above, the anti-shake unit 42 shown in FIG. 4 is operated in such a manner that the image sensor 20 is desirably moved or oscillated to correct a displacement of the optical axis “L” of the lens unit 2 in an exposure period by the image sensor 20 if the displacement of the optical axis “L” has occurred due to shake of the camera body 1A, and that the optical device 26 is desirably moved or oscillated to correct a displacement of the optical axis “L′” of the viewfinder section 23 if the displacement of the optical axis “L′” has occurred when the user has viewed an object light image i.e. a viewfinder image through the viewfinder window 10 in a period other than the exposure period. The optical device 26 is an optical device for correcting a shake of the viewfinder image displayed by the viewfinder section 23. Accordingly, hereinafter, the optical device 26 is called as “viewfinder anti-shake optical system 26”.

FIG. 5 is a block diagram showing an electrical configuration of the digital camera 1. A lens unit 2 in FIG. 5 corresponds to the lens unit 2 shown in FIG. 1, and includes a photographing optical system 76 provided with the zoom lens group 74 and the focus lens group 75. The photographing optical system 76 is encased in an unillustrated lens barrel. A shake detecting sensor 9 and an eyepiece sensor 11 in FIG. 5 correspond to the shake detecting sensor 9 and the eyepiece sensor 11 shown in FIG. 1, respectively. Output signals from the shake detecting sensor 9 and the eyepiece sensor 11 are sent to the main controller 91.

A lens driver 77 includes a helicoid and an unillustrated gear for rotating the helicoid, for instance. The lens driver 77 moves the photographing optical system 76 in a direction parallel to the optical axis “L” upon receiving a driving force from an AF actuator 78 by way of an unillustrated coupler. A moving direction and a moving amount of the photographing optical system 76 are determined based on the rotation direction and the rotation number of the AF actuator 78, respectively.

A lens encoder 79 includes an encoder plate in which plural code patterns are formed at a certain pitch in the direction of the optical axis “L” within a movable range of the photographing optical system 76, and an encoder brush which is integrally moved with the lens barrel in sliding contact with the encoder plate. The lens encoder 79 detects the moving amount of the photographing optical system 76 at the time of focus control.

A storage 80 includes the aforementioned lens ROM and a Random Access Memory (RAM), and stores information such as the moving amount of the photographing optical system 76 sent from the lens encoder 79 for outputting to the main controller 91.

An image sensor 20 in FIG. 5 corresponds to the image sensor 20 shown in FIG. 2. A timing control circuit 84 to be described later controls start and end of an exposure operation of the image sensor 20, and an image capturing operation e.g. a readout operation of output signals from the respective pixels of the image sensor 20 such as horizontal synchronization, vertical synchronization, and transfer.

A viewfinder anti-shake optical system 26 in FIG. 5 corresponds to the viewfinder anti-shake optical system 26 shown in FIGS. 2 and 3. As described above, the viewfinder anti-shake optical system 26 is integrally movable with the image sensor 20. Referring to FIG. 5, the double line connecting the viewfinder anti-shake optical system 26 and the image sensor 20 represents that the viewfinder anti-shake optical system 26 and the image sensor 20 are integrally movable.

An anti-shake unit 42 in FIG. 5 corresponds to the anti-shake unit 42 shown in FIG. 4, and an operation thereof is controlled by the main controller 91. Specifically, the image sensor 20 and the viewfinder anti-shake optical system 26 are driven based on a command issued from the main controller 91 relating to the moving directions and the moving amounts of the image sensor 20 and the viewfinder anti-shake optical system 26.

The mirror section 21 includes the main mirror 27 and the sub mirror 28. A mirror driver 81 drives the main mirror 27 and the sub mirror 28 between their respective tilted positions and horizontal positions. The operation of the mirror driver 81 is controlled by the main controller 91.

A signal processor 82 is adapted to apply a predetermined analog signal processing to an analog image signal outputted from the image sensor 20. The signal processor 82 includes a correlated double sampling (CDS) circuit for reducing noise in sampling an image signal, and an auto gain control (AGC) circuit for adjusting the level of the image signal.

An analog-to-digital (A/D) converter 83 is adapted to convert analog pixel signals of R, G, and B which have been outputted from the signal processor 82 into digital pixel signals of plural bits e.g. 10 bits.

The timing control circuit 84 generates clocks CLK1 and CLK2 based on a reference clock CLK0 outputted from the main controller 91. The timing control circuit 84 controls operations of the image sensor 20 and the A/D converter 83 by outputting the clock CLK1 to the image sensor 20, and the clock CLK2 to the A/D converter 83, respectively.

An image memory 85 is a memory which is adapted to temporarily store image data outputted from an image processor 86, and is used as a work area where various processing are applied to the image data by the main controller 91 when the camera 1 is in the photographing mode, and is a memory for temporarily storing image data which has been read out from the external storage 88 to be described later by the main controller 91 when the camera 1 is in the playback mode.

The image processor 86 applies a predetermined image processing to the output data from the A/D converter 83. Examples of the image processing are black level correction for converting the black level of image data into a reference black level, white balance correction for performing level conversion of pixel data of the respective color components of R, G, and B based on white reference data depending on a light source, and gamma correction for correcting gamma characteristics of the pixel data of the respective color components of R, G, and B.

A VRAM 87 has a storage capacity capable of recording image signals corresponding to the number of pixels of the external display section 12, and serves as a buffer memory for storing pixel signals constituting an image to be played back on the external display section 12. The external display section 12 in FIG. 5 corresponds to the external display section 12 in FIG. 2. The external storage 88 includes a memory card such as a semiconductor storage device, and a hard disk, and is adapted to store image data generated in the main controller 91.

An operation input section 89 includes the control value setting dial 5, the mode setting dial 6, the shutter button 7, the power switch 13, the direction selecting key 14, and the anti-shake switch 15. The user is allowed to input information relating to operations of the camera 1 to the main controller 91 by way of the operation input section 89.

The main controller 91 includes a Read Only Memory (ROM) for storing various control programs, a Random Access Memory (RAM) for temporarily storing data such as computation processing or control processing, and a central processing unit (CPU) for reading out the control program or the like from the ROM for execution. The main controller 91 controls a photographing operation, a playback operation, and an anti-shake operation by correlating the driving of the respective parts in the camera body 1A shown in FIG. 5 upon receiving various signals from the shake detecting sensor 9, the eyepiece sensor 11, the operation input section 89, the lens driver 77, and the mirror driver 81.

In this embodiment, as mentioned above, in the case where a displacement of the optical axis “L” of the photographing optical system 76 has occurred during an exposure period by the image sensor 20, the image sensor 20 is desirably moved or oscillated to correct the displacement of the optical axis “L”, and in the case where a displacement of the optical axis “L′” of the viewfinder section 23 has occurred while the user has viewed a viewfinder image through the viewfinder window 10 during a period other than the exposure period, the viewfinder anti-shake optical system 26 is desirably moved or oscillated to correct the displacement of the optical axis “L′”. The main controller 91 is functionally provided with a judger 92, and an anti-shake controller 93 serving as a driver controller to attain this function. The judger 92 and the anti-shake controller 93 execute their respective processing when an anti-shake function is turned on in response to the user's depressing of the anti-shake switch 15.

The judger 92 judges whether the driving control of the viewfinder anti-shake optical system 26 is to be executed, or the driving control of the image sensor 20 is to be executed, based on detection signals from the eyepiece sensor 11 and the shutter button 7. This operation is necessary in this embodiment because driving amounts i.e. anti-shake amounts required for the viewfinder anti-shake optical system 26 and the image sensor 20 differ between the driving control of the viewfinder anti-shake optical system 26 and the driving control of the image sensor 20 in the case where the anti-shake amounts are calculated based on a detection signal from the shake detecting sensor 9 due to the design configuration of the digital camera 1.

Also, in the viewfinder section 23, an object light image i.e. a viewfinder image is guided to the viewfinder window 10 by the viewfinder anti-shake optical system 26 having a positive optical power. Therefore, even if the same object light image is guided, the light image guided to the image sensor 20 and the light image guided to the viewfinder section 23 are inverted to each other in vertical and sideways directions. Consequently, the driving directions i.e. shake canceling directions are made opposite to each other in driving control of the viewfinder anti-shake optical system 26 and in driving control of the image sensor 20.

Because of the above reason, it is necessary to judge whether the driving control of the viewfinder anti-shake optical system 26 or the driving control of the image sensor 20 is to be executed. The judger 92 judges that the driving control of the image sensor 20 is to be executed irrespective of a detection result by the eyepiece sensor 11 for the viewfinder window 10 if the shutter button 7 is fully depressed. If, however, a camera shake is detected in a period until the shutter button 7 is fully depressed while the user has viewed a viewfinder image through the viewfinder window 10 based on a detection result by the eyepiece sensor 11, the judger 92 judges that the driving control of the viewfinder anti-shake optical system 26 is to be executed. If the shutter button 7 is not fully depressed, and if the user's viewing the viewfinder image through the viewfinder window 10 is not detected for a predetermined duration, the judger 92 may make a judgment so that both of the driving controls of the image sensor 20 and the viewfinder anti-shake optical system 26 are suspended.

The anti-shake controller 93 controls the operation of the anti-shake unit 42 based on a judgment result by the judger 92. Specifically, if the judger 92 judges that the driving control of the viewfinder anti-shake optical system 26 is to be executed, the anti-shake controller 93 calculates an anti-shake amount based on a shake amount obtained from a detection signal of the shake detecting sensor 9, using a predetermined computing equation for correcting the shake of the object light image i.e. the viewfinder image displayed by the viewfinder section 23. Then, the anti-shake unit 42 drives the viewfinder anti-shake optical system 26 based on the calculated anti-shake amount for anti-shake control.

If, on the other hand, the judger 92 judges that the driving control of the image sensor 20 is to be executed, the anti-shake controller 93 calculates an anti-shake amount based on a shake amount obtained from a detection signal of the shake detecting sensor 9, using a predetermined computing equation for correcting the shake of the object light image captured by the image sensor 20. Then, the anti-shake unit 42 drives the image sensor 20 based on the calculated anti-shake amount for anti-shake control.

The computing equation to be used in driving control of the viewfinder anti-shake optical system 26 can be expressed by e.g. Δx=−(k×t)×m where “m” is a shake amount obtained from a detection signal of the shake detecting sensor 9, Δx is a driving amount i.e. an anti-shake amount, and “k” is a coefficient, if the computing equation to be used in driving control of the image sensor 20 is expressed by Δx=k×m. The coefficients “k” and “t” are coefficients that are determined depending on the pixel number of the image sensor 20, optical characteristics such as a radius of curvature of the viewfinder anti-shake optical system 26, detection precision of the shake detecting sensor 9, or the like.

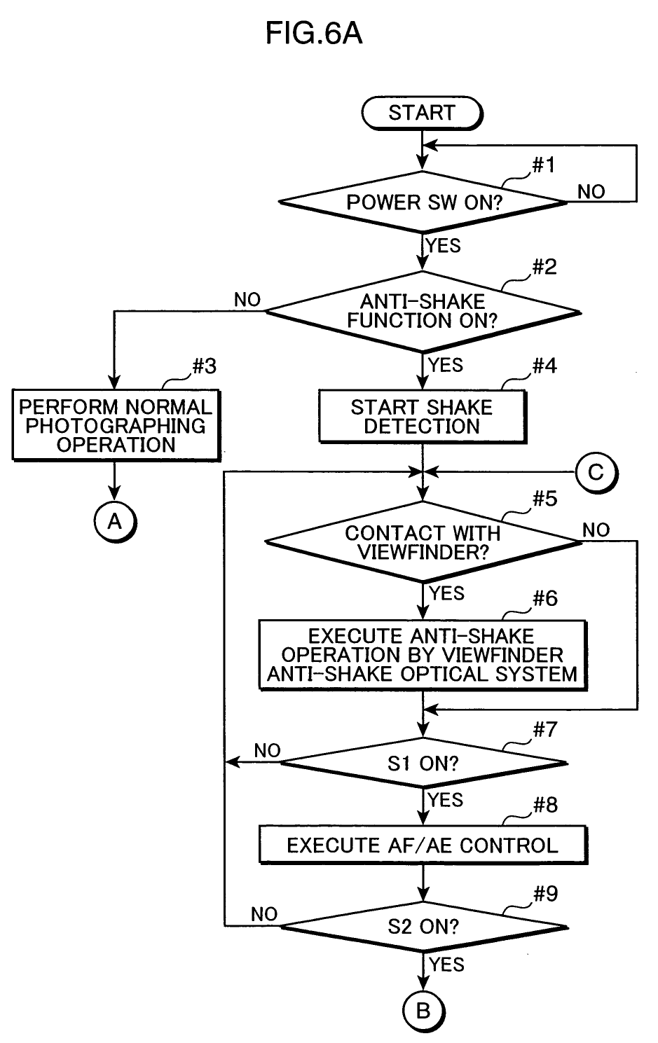

Next, an anti-shake processing to be executed by the digital camera 1 having the above configuration is described. FIGS. 6A and 6B are a flowchart showing the anti-shake processing to be executed by the digital camera 1 in the embodiment. The following processing is described on a premise that the digital camera 1 is set to the photographing mode by the mode setting dial 6 and that an operation of changing over from the photographing mode to the playback mode is not performed.

Referring to FIGS. 6A and 6B, the main controller 91 judges whether the main power source of the digital camera 1 is turned on, in other words, the power switch 13 is depressed (Step #1). If the main controller 91 judges that the power switch 13 is depressed (YES in Step #1), the main controller 91 judges whether the anti-shake function is turned on, in other words, the anti-shake switch 15 is depressed (Step #2). If the main controller 91 judges that the anti-shake switch 15 is not depressed (NO in Step #2), the main controller 91 controls the respective parts of the digital camera 1 to execute a normal photographing operation (Step #3).

If, on the other hand, the main controller 91 judges that the anti-shake function is turned on (YES in Step #2), the main controller 91 controls the shake detecting sensor 9 to start detection of a camera shake (Step #4).

Next, the main controller 91 judges whether the user's eye has contacted or come close to the viewfinder window 10 based on a detection signal from the eyepiece sensor 11 (Step #5). If the main controller 91 judges that the user has viewed the viewfinder image (YES in Step #5), an anti-shake operation by the viewfinder anti-shake optical system 26 is executed (Step #6). Thereby, the user can visually recognize the object light image with no or less image blur through the viewfinder window 10. If, on the other hand, the main controller 91 judges that the user has not viewed the viewfinder image (NO in Step #5), the routine proceeds to Step #7 while skipping the processing in Step #6.

After the processing in Step #5 or #6, the main controller 91 judges whether the shutter button 7 is halfway depressed (Step #7). If the main controller 91 judges that the shutter button 7 is not halfway depressed (NO in Step #7), the routine returns to the processing in Step #5. If the main controller 91 judges that the shutter button 7 is half-way depressed (YES in Step #7), the main controller 91 controls the focus detecting section 29 to execute a focus control, and controls an unillustrated metering sensor to execute an exposure control (Step #8), and thereafter judges whether the shutter button 7 is fully depressed (Step #9).

If the main controller 91 judges that the shutter button 7 is not fully depressed (NO in Step #9), the routine returns to the processing in Step #5. If the main controller 91 judges that the shutter button 7 is fully depressed (YES in Step #9), the main controller 91 controls the viewfinder anti-shake optical system 26 to suspend the anti-shake operation (Step #10), and controls the image sensor 20 to execute an anti-shake operation (Step #11). Thereby, an object light image with no or less image blur is captured by the image sensor 20.

Then, the main controller 91 controls the mirror driver 81 to drive the main mirror 27 and the sub mirror 28 to their respective horizontal positions, in other words, to execute a mirror-up operation (Step #12). After the mirror-up operation, the main controller 91 controllably opens the shutter section 35 (Step #13), and controls the image sensor 20 to execute an image capturing operation i.e. an exposure operation in a state that the focus lens group 75 is positioned at the position set in Step #8, and with the exposure control value set in Step #8 (Step #14). Thereby, an object light image with no or less image blur is captured.

Thereafter, the main controller 91 controllably closes the shutter section 35 (Step #15), controls the mirror driver 81 to drive the main mirror 27 and the sub mirror 28 to their respective tilted positions, in other words, to execute a mirror-down operation (Step #16), and controls the image sensor 20 to suspend the anti-shake operation (Step #17).

Then, the main controller 91 judges whether the main power source of the digital camera 1 is turned off, in other words, the power switch 13 is depressed (Step #18). If the main controller 91 judges that the power source is not changed to an OFF-state (NO in Step #18), the routine returns to the processing in Step #5. If, on the other hand, the main controller 91 judges that the power source is changed to an OFF-state (YES in Step #18), the routine ends.

As mentioned above, in this embodiment, in light of the point that display of an object light image i.e. a viewfinder image by the viewfinder section 23, and an exposure operation by the image sensor 20 are not executed concurrently, the viewfinder anti-shake optical system 26 and the image sensor 20 are made integrally movable by interconnecting the viewfinder anti-shake optical system 26 to the heat releaser 48 by the linking member 70 so as to correct an image blur of the object light image captured by the image sensor 20 during the exposure period of the image sensor 20, and to correct an image blur of the viewfinder image displayed by the viewfinder section 23 while the user has viewed the viewfinder image through the viewfinder window 10 during a period other than the exposure period. This not only enables to record an image with no or less image blur but also allows the user to visually recognize the viewfinder image with no or less image blur while viewing the viewfinder image through the viewfinder window 10.

In the above arrangement, the driving of the image sensor 20 and the driving of the viewfinder anti-shake optical system 26 can be executed by the yaw actuator 40 and the pitch actuator 41 in pair. This enables to suppress cost increase and size increase of the digital camera 1, as compared with an arrangement that the driving of the image sensor 20 and the driving of the viewfinder anti-shake optical system 26 are executed by individual drivers.

The image sensor 20 and the viewfinder anti-shake optical system 26 are integrally movable by the linking member 70 provided with the arm portion 71 extending upwardly from the upper end portion of the heat releaser 48, and the annular-shaped ring portion 72. This enables to realize the arrangement of integrally moving the viewfinder anti-shake optical system 26 and the image sensor 20 with a simplified construction.

The computing equations for calculating the anti-shake amounts for the image sensor 20 and for the anti-shake optical system 26 based on the shake amount detected by the shake detecting sensor 9 in the exposure period i.e. a mode where the exposure operation by the image sensor 20 is executed, and in the other period i.e. a mode where the viewfinder image is viewed through the viewfinder window 10 are respectively predefined based on design-related contents including the pixel number of the image sensor 20, optical characteristics such as the radius of curvature of the viewfinder anti-shake optical system 26, and detection precision of the shake detecting sensor 9 to calculate the driving amounts i.e. the anti-shake amounts based on the shake amount, using the computing equations corresponding to the respective modes. This enables to perform proper anti-shake control in accordance with the respective anti-shake modes.

The invention may include the following modified embodiments (1) through (5) in addition to or in place of the foregoing embodiment.

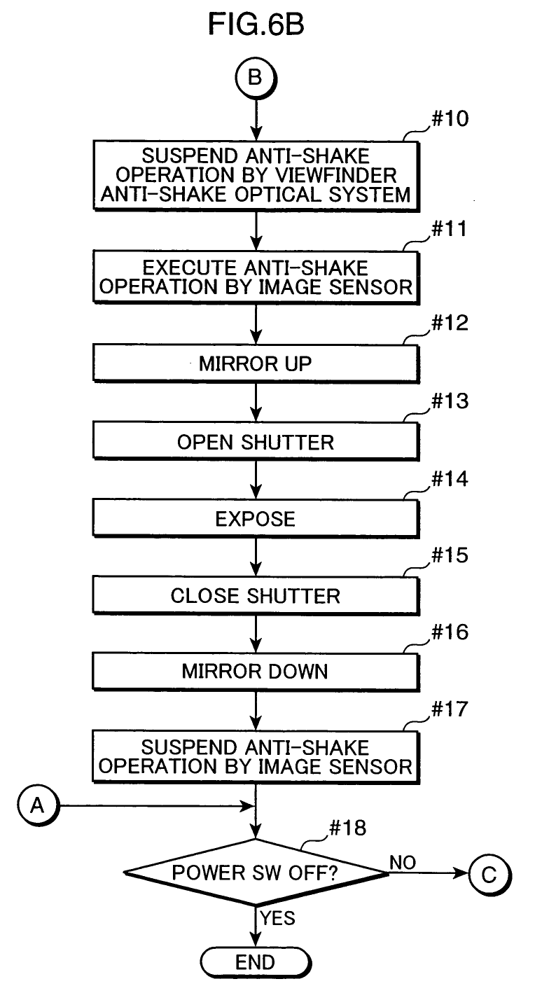

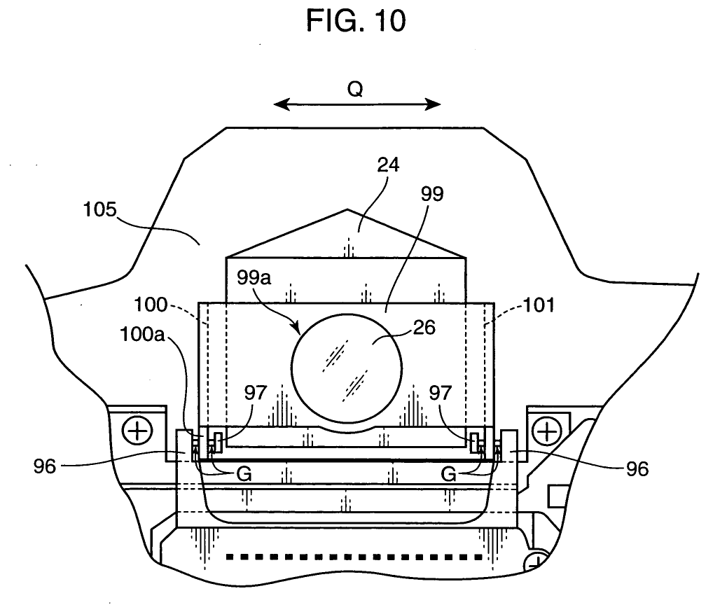

(1) The mechanical arrangement for moving the viewfinder anti-shake optical system 26 in association with the image sensor 20 is not limited to the linking member 70, but may be an arrangement as shown in FIGS. 7 through 10, for instance. FIG. 7 is a front view of the modified arrangement. FIG. 8 is a plan view of the modified arrangement. FIG. 9 is a side view of the modified arrangement. FIG. 10 is a rear view of the modified arrangement. Elements in the modified arrangement identical or substantially equivalent to those in the embodiment are denoted by the same reference numerals.

As shown in FIGS. 7 through 10, in the first modified embodiment, the modified arrangement comprises a movable member 94, a rod member 95, extensions 96 formed on a heat releaser 48, and linking pins 97 for moving a viewfinder anti-shake optical system 26 in association with an image sensor 20, in place of using the linking member 70.

The movable member 94 has such a shape as to cover optical devices i.e. a penta prism 24 and an eyepiece lens unit 25 from a side portion of a camera body. As primarily shown in FIG. 8, the movable member 94 has a cylindrical portion 98 disposed on a front side of the camera body i.e. the side of a lens unit 2, a rear wall portion 99 disposed on a rear side of the camera body i.e. the side of a viewfinder window 10, a side wall portion 100 formed between one ends of the cylindrical portion 98 and the rear wall portion 99, and a side wall portion 101 formed between the other ends of the cylindrical portion 98 and the rear wall portion 99.

The cylindrical portion 98 has a cylindrical shape with a through-hole 98a (see FIG. 9) of a predetermined diameter. The rod member 95 to be described later is rotatably fitted in the through-hole 98a of the cylindrical portion 98 relative thereto. The rear wall portion 99 has a planar shape extending substantially parallel to the viewfinder window 10, and has a hollow portion 99a (see FIG. 10) of a predetermined diameter substantially in the widthwise center thereof. The viewfinder anti-shake optical system 26 is fitted in the hollow portion 99a, so that the viewfinder anti-shake optical system 26 is integrally movable with the rear wall portion 99, and accordingly, with the movable member 94.

The side wall portions 100 and 101 have substantially identical shapes to each other, and are formed with extensions 110a and 110a extending from lower end portions thereof at a position close to the rear wall portion 99 toward the image sensor 20, respectively. Unillustrated holes are formed at appropriate positions of the extensions 100a and 101a for receiving the linking pins 97, which will be described later.

The rod member 95 has a cylindrical column portion 95a of a circular shape in cross section with a diameter substantially the same as the diameter of the through-hole 98a of the cylindrical portion 98, and a pin 95b projecting in a direction substantially orthogonal to the axial direction at a substantially axially center of the cylindrical column portion 95a. The cylindrical column portion 95a is rotatably fitted in the through-hole 98a of the cylindrical portion 98 relative thereto. The pin 95b protrudes from an appropriate position of the cylindrical portion 98. The pin 95b is fitted in an appropriate position of a frame member 36 to restrain the cylindrical column portion 95a from circumferentially pivoting. With this arrangement, the movable member 94 is made rotatable relative to the rod member 95 in the directions shown by the arrows “P” in FIG. 9.

Referring to FIG. 10, the extensions 96 formed on the heat releaser 48 extend in such a direction as to cover outer areas of the extensions 110a and 110a of the side wall portions 100 and 101, respectively. Mechanically linking the extensions 100a and 101a of the movable member 94 to the extensions 96 by the linking pins 97 enables to interlink the extensions 96 to the movable member 94 at an upper end portion thereof.

Referring to FIGS. 8 and 10, a mechanical allowance “G” is provided to make the movable member 94 movable relative to the respective extensions 96 by a predetermined distance in sideways directions i.e. the directions shown by the arrows “Q” in FIG. 10 in a state that the extensions 96 and the linking pins 97 are mechanically connected. This arrangement enables to make the viewfinder anti-shake optical system 26 and the movable member 94 movable in sideways directions i.e. the directions of the arrows “Q”, as well as in the vertical directions.

With the above arrangement, when the image sensor 20 is driven in the directions shown by the arrows “W” in FIG. 9, for instance, the movable member 94 is pivoted in the directions shown by the arrows “P” about the axis of the rod member 95. On the other hand, when the image sensor 20 is driven in the directions shown by the arrows “Q” in FIG. 10, the movable member 94 is pivoted in the directions shown by the arrows “Z” in FIG. 8 about the axis of the pin 95b.

The above modified arrangement also enables to drive the viewfinder anti-shake optical system 26 in two axis directions on a plane substantially perpendicular to the optical axis “L′” of a viewfinder section 23 to thereby eliminate or suppress an image blur of an object light image guided to the viewfinder window 10.

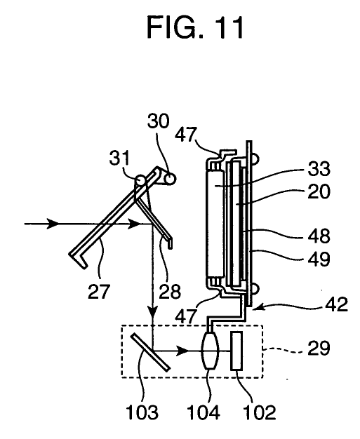

(2) An optical device provided in the focus detecting section 29 i.e. a focus adjusting mechanism may be made movable in association with the image sensor 20, in place of the viewfinder anti-shake optical system 26. FIG. 11 shows a second modified embodiment in the case where an optical device provided in a focus detecting section 29 is made movable in association with an image sensor 20. As in the case of the first modified embodiment, elements in the second modified embodiment identical or substantially equivalent to those in the embodiment are denoted by the same reference numerals.

Referring to FIG. 11, the focus detecting section 29 includes a metering device 102 with a light receiving plane thereof substantially parallel to the light receiving plane of the image sensor 20, a mirror 103 for reflecting light reflected on a sub mirror 28 toward the metering device 102, and an optical device 104 which is arranged on an optical path between the mirror 103 and the metering device 102 to focus an object light image guided through the mirror 103 onto the light receiving plane of the metering device 102.

The focus detecting section 29 may be constructed, similarly to the arrangement of the viewfinder anti-shake optical device 26, in such a manner that the optical device 104 is movable in association with the image sensor 20 by a member substantially equivalent to the linking member 70. This arrangement enables to perform high-precision focus detection while eliminating or suppressing an image blur of the object light image guided to the metering device 102.

(3) In the foregoing embodiment, in response to detection of the user's viewing a viewfinder image through the viewfinder window 10 by the eyepiece sensor 11, the viewfinder anti-shake optical system 26 starts its driving to eliminate or suppress an image blur of the viewfinder image displayed through the viewfinder window 10. Alternatively, when a grip sensor 4a detects gripping of the camera body, the user's viewing of a viewfinder image through the viewfinder window 10 may be detected to start driving the viewfinder anti-shake optical system 26. Further alternatively, in the case where the digital camera has a mechanism for detecting a photographing preparatory state of the camera, the mechanism may detect a predetermined photographing preparatory operation of the camera so as to start driving the viewfinder anti-shake optical system 26.

(4) In the embodiment, each time the anti-shake switch 15 is depressed, on/off of the anti-shake mode is switched over, and the camera is selectively set to the mode of correcting an image blur of an object light image guided to the light receiving plane of the image sensor 20 by driving of the image sensor 20, and the mode of correcting an image blur of an object light image displayed through the viewfinder window 10 by driving of the viewfinder anti-shake optical system 26 when the anti-shake mode is in an ON-state. Alternatively, either one of the correction modes may be selected for execution when the anti-shake mode is turned on.

For instance, in a continuous photographing operation, it is preferred to constantly perform an anti-shake operation by the image sensor 20, and accordingly, there is no need of changing over the correction mode to the mode of correcting an image blur by the viewfinder section 23. Accordingly, in the case where the continuous photographing mode is set while the anti-shake mode is in an ON-state, the digital camera may be operative to activate merely the mode of correcting an image blur of an object light image guided to the light receiving plane of the image sensor 20 by driving the image sensor 20. In photographing using a telephoto lens, an image blur by the viewfinder section 23 is increased. However, there is no need of performing an anti-shake operation by the image sensor 20 as far as the shutter speed is sufficiently fast. Accordingly, in such a case, the camera may be operative to execute merely an anti-shake operation of the viewfinder section 23, namely, to execute merely the mode of correcting an image blur of an object light image displayed through the viewfinder window 10 by driving the viewfinder anti-shake optical system 26, and may be operative to suspend the anti-shake driving during a photographing operation so as to prohibit the anti-shake control in the photographing operation.

(5) The linking member 70 may be mounted on the image sensor substrate 49 in place of the heat releaser 48. In other words, the linking member 70 may be mounted on any member, as far as the position, the configuration, or other factor of the viewfinder anti-shake optical system 26 allows to do so.

The aforementioned embodiment primarily includes the following.

An aspect of the invention is directed to an image sensing apparatus comprising: an optical path splitter for splitting a flux of light from an object guided through a photographing optical system into a plurality of optical paths; an image sensor for photoelectrically converting the light passing along a first optical path of the optical paths; a driver for driving the image sensor on a plane intersecting with an optical axis of the photographing optical system; a shake detector for detecting a shake given to the image sensing apparatus; a driver controller for controlling the driver to drive the image sensor based on an output from the shake detector so as to correct an image blur of a light image of the object captured on a light receiving plane of the image sensor; an anti-shake optical system disposed on a second optical path different from the first optical path of the optical paths; and a mechanical linking mechanism for enabling driving of the anti-shake optical system in association with the driving of the image sensor by the driver.

With the above arrangement, since the image sensing apparatus has the mechanical linking mechanism for enabling the driving of the anti-shake optical system in association with the driving of the image sensor by the driver, the anti-shake optical system is movable in association with the image sensor.

Preferably, the linking mechanism includes a support member for integrally and fixedly supporting the image sensor, and a linking member which is fixed to the anti-shake optical system and the support member.

With the above arrangement, the lining mechanism includes the support member for integrally and fixedly supporting the image sensor, and the linking member which is fixed to the anti-shake optical system and the support member. This enables to realize an arrangement for mechanically linking the image sensor to the anti-shake optical system with a simplified construction as far as the support member for integrally and fixedly supporting the image sensor, and the anti-shake optical system are arranged in proximity to each other.

Preferably, in the above arrangement, the image sensing apparatus further comprises an optical viewfinder for optically displaying a light image of the object guided through the photographing optical system, wherein the second optical path is an optical path for the object light image from the optical path splitter to the optical viewfinder, and the anti-shake optical system is an optical system for correcting an image blur of the object light image displayed through the optical viewfinder.

With the above arrangement, the second optical path is the optical path for the object light image from the optical path splitter to the optical viewfinder, and the anti-shake optical system is the optical system for correcting the image blur of the object light image displayed through the optical viewfinder. This enables to correct the image blur of the object light image displayed through the optical viewfinder.

Preferably, in the above arrangement, the image sensing apparatus further comprises a mode setter for selectively setting the image sensing apparatus between a first mode of correcting an image blur of a light image of the object captured on a light receiving plane of the image sensor, and a second mode of correcting an image blur of a light image of the object displayed through the optical viewfinder, wherein the driver controller changes a driving manner of the driver in accordance with the mode set by the mode setter.

With the above arrangement, the driving manner of the driver is changed in accordance with the set mode between the first mode of correcting the image blur of the object light image captured on the light receiving plane of the image sensor, and the second mode of correcting the image blur of the object light image displayed through the optical viewfinder. This enables to perform a proper anti-shake operation depending on the respective modes.

Preferably, in the above arrangement, the anti-shake optical system includes an optical system having a positive optical power, and the driver controller controls the driver to drive the anti-shake optical system in a direction opposite to a driving direction of the image sensor in setting of the first mode in response to an output of a polarity identical to a polarity of the shake detector when the second mode is set by the mode setter.

With the above arrangement, since the anti-shake optical system includes the optical system having the positive optical power, the shake direction of the object light image captured by the image sensor and the shake direction of the object light image displayed through the optical viewfinder are opposite to each other. In this case, when the second mode is set by the mode setter, the anti-shake optical system is driven in the direction opposite to the driving direction of the image sensor in setting of the first mode in response to the output of the polarity identical to the polarity of the shake detector. This enables to perform a proper anti-shake operation when the second mode is set because the anti-shake optical system includes the optical system having the positive optical power.

Preferably, in the above arrangement, the mode setter changes over the image sensing apparatus between the first mode and the second mode based on an input for the image sensing apparatus or an operation state of the image sensing apparatus.

With the above arrangement, the changeover between the first mode and the second mode can be performed according to the user's intention or automatically.

Preferably, in the above arrangement, the image sensing apparatus further comprises an operation input section for allowing a user to input a designation to generate an image to be recorded in a recorder, wherein the mode setter sets the first mode upon receiving the designation by way of the operation input section.

With the above arrangement, in response to the input of the designation to generate the image to be recorded in the recorder, the mode setter sets the first mode. This enables to eliminate or suppress an image blur of the object light image captured by the image sensor, and accordingly, the image to be recorded in the recorder.

Preferably, in the above arrangement, the image sensing apparatus further comprises a contact sensor for detecting whether the user's eye has contacted or come close to the optical viewfinder, and the mode setter sets the image sensing apparatus to the second mode when the contact sensor detector detects that the user's eye has contacted or come close to the optical viewfinder.

With the above arrangement, the mode setter sets the image sensing apparatus to the second mode when the contact sensor detects that the user's eye has contacted or come close to the optical viewfinder. Thus, the image blur of the viewfinder image displayed through the optical viewfinder is corrected when the contact sensor detects that the user's eye has contacted or come close to the optical viewfinder. This allows the user to visually recognize the viewfinder image with no or less image blur.

As mentioned above, according to the embodiment and the modified embodiments of the invention, since the anti-shake optical system and the image sensor are made movable in association with each other, the image sensor and the anti-shake optical system can be driven by a single driver. Accordingly, the embodiment and the modified embodiments of the invention are advantageous in suppressing cost increase and size increase of the image sensing apparatus by utilizing the driver for driving the image sensor, and in executing an anti-shake control for the mechanism provided with the anti-shake optical system, other than the image sensor.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image sensing apparatus comprising:
an optical path splitter for splitting a flux of light from an object guided through a photographing optical system into a plurality of optical paths;
an image sensor for photoelectrically converting the light passing along a first optical path of the optical paths;
a driver for driving the image sensor on a plane intersecting with an optical axis of the photographing optical system;
a shake detector for detecting a shake given to the image sensing apparatus;
a driver controller for controlling the driver to drive the image sensor based on an output from the shake detector so as to correct an image blur of a light image of the object captured on a light receiving plane of the image sensor;
an anti-shake optical system disposed on a second optical path different from the first optical path of the optical paths; and
a mechanical linking mechanism for enabling driving of the anti-shake optical system in association with the driving of the image sensor by the driver.

2. The image sensing apparatus according to claim 1, wherein
the linking mechanism integrally and fixedly supports the anti-shake optical system and the image sensor.

3. The image sensing apparatus according to claim 1, wherein
the linking mechanism includes
a movable member which is provided independently of a member integral with the image sensor to support the anti-shake optical system, and is mechanically linked to the member integral with the image sensor for integral movement.

4. The image sensing apparatus according to claim 1, further comprising:
an optical viewfinder for optically displaying a light image of the object guided through the photographing optical system, wherein
the second optical path is an optical path for the object light image from the optical path splitter to the optical viewfinder.

5. The image sensing apparatus according to claim 1, further comprising:
a mode setter for selectively setting the image sensing apparatus between a first mode of correcting an image blur of a light image of the object on the first optical path, and a second mode of correcting an image blur of a light image of the object on the second optical path, wherein
the driver controller changes a driving manner of the driver in accordance with the mode set by the mode setter.

6. The image sensing apparatus according to claim 5, wherein
the driver controller changes a driving amount of the driver in accordance with the mode set by the mode setter.

7. The image sensing apparatus according to claim 5, wherein
the driver controller changes a driving direction of the driver in accordance with the mode set by the mode setter.

8. The image sensing apparatus according to claim 5, wherein
the anti-shake optical system includes an optical system having a positive optical power, and
the driver controller controls the driver to drive the anti-shake optical system in a direction opposite to a driving direction of the image sensor in setting of the first mode in response to an output of a polarity identical to a polarity of the shake detector when the second mode is set by the mode setter.

9. The image sensing apparatus according to claim 8, further comprising:
an optical viewfinder for optically displaying a light image of the object guided through the photographing optical system, wherein
the second optical path is an optical path for the object light image from the optical path splitter to the optical viewfinder.

10. The image sensing apparatus according to claim 5, wherein
the mode setter changes over the image sensing apparatus between the first mode and the second mode based on an input for the image sensing apparatus or an operation state of the image sensing apparatus.

11. The image sensing apparatus according to claim 5, further comprising:
an operation input section for allowing a user to input a designation to generate an image to be recorded in a recorder, wherein
the mode setter sets the first mode upon receiving the designation by way of the operation input section.

12. The image sensing apparatus according to claim 4, further comprising:
a contact sensor for detecting whether the user's eye has contacted or come close to the optical viewfinder; and
a mode setter for changing over the image sensing apparatus from a first mode of correcting an image blur of a light image of the object on the first optical path to a second mode of correcting an image blur of a light image of the object on the second optical path when the contact sensor detects that the user's eye has contacted or come close to the optical viewfinder.

13. The image sensing apparatus according to claim 1, further comprising:
a focus adjusting mechanism for detecting a focal position of a focus adjusting lens in the photographing optical system, wherein
the second optical path is an optical path from the optical path splitter to the focus adjusting mechanism.

14. An image sensing apparatus comprising:
a photographing optical system;
an image sensor for photoelectrically converting light from an object guided through the photographing optical system;
an optical viewfinder for optically displaying a light image from the object guided through the photographing optical system;
an optical path splitter for selectively guiding a flux of the light from the object guided through the photographing optical system along a first optical path directed to the image sensor and along a second optical path directed to the optical viewfinder;
a driver for driving the image sensor on a plane intersecting with an optical axis of the photographing optical system;
a shake detector for detecting a shake given to the image sensing apparatus;
an anti-shake optical system disposed on the second optical path;
a driver controller for controlling the driver to drive the image sensor based on an output from the shake detector so as to correct an image blur of a light image of the object captured on a light receiving plane of the image sensor; and
a mechanical linking mechanism for enabling driving of the anti-shake optical system in association with the driving of the image sensor by the driver.

15. The image sensing apparatus according to claim 14, further comprising:
a mode setter for selectively setting the image sensing apparatus between a first mode of correcting an image blur of a light image of the object on the first optical path, and a second mode of correcting an image blur of a light image of the object on the second optical path, wherein
the driver controller changes a driving manner of the driver in accordance with the mode set by the mode setter.

16. The image sensing apparatus according to claim 15, wherein
the driver controller controls the driver to drive the anti-shake optical system in a direction opposite to a driving direction of the image sensor in setting of the first mode in response to an output of a polarity identical to a polarity of the shake detector when the second mode is set by the mode setter.

17. The image sensing apparatus according to claim 15, wherein
the driver controller changes a driving amount of the driver in response to an output of a polarity identical to a polarity of the shake detector between a case where the first mode is set and a case where the second mode is set.

18. The image sensing apparatus according to claim 15, further comprising:
a contact sensor for detecting whether the user's eye has contacted or come close to the optical viewfinder, wherein
the mode setter changes over the image sensing apparatus from the first mode to the second mode when the contact sensor detects that the user's eye has contacted or come close to the optical viewfinder.

19. The image sensing apparatus according to claim 15, wherein
the mode setter is operative to execute exclusively the first mode when the image sensing apparatus is set in a continuous photographing mode.
